(19) United States
(12) Patent Application Publication
(10) Pub. No.: US 2006/0076354 A1
(43) Pub. Date: Apr. 13, 2006

(54) Hydrogen storage apparatus

(76) Inventor: John Francis Lanzafame, Victor, NY (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/244,376

(22) Filed: Oct. 6, 2005

Related U.S. Application Data
(63) Continuation-in-part of application No. 11/042,219, filed on Jan. 25, 2005.
(60) Provisional application No. 60/616,655, filed on Oct. 7, 2004.

(51) Int. Cl. H01M 2/02; F17C 13/00

(52) U.S. Cl. 220/560.04; 429/34

(57) ABSTRACT

Disclosed is hydrogen storage processes and assemblies using metallized halloysite or metalized lipids. The addition of metals or metal salts increases the hydrogen storage ability of the halloysite or lipids relative to their non-metallized state.

### CROSS-REFERENCE TO RELATED APPLICATIONS

This application claims the benefit of U.S. Provisional Application No. 60/616,655 filed on Oct. 7, 2004. This application is also a continuation-in-part of applicant's copending patent application U.S. Ser. No. 11/042,219, filed on Jan. 25, 2005. The entire disclosure of each of these applications is hereby incorporated by reference into thic specification.

### FIELD OF THE INVENTION

This invention relates to processes and assemblies for the storage of hydrogen gas, and more particularly, to the use of metalized inorganic and organic tubules in such processes and assemblies.

### BACKGROUND OF THE INVENTION

There has been a long felt need to increase the ability to store hydrogen gas. Fuel cells, for example, utilize hydrogen gas to produce energy, but their use has been limited by the inability to efficiently store hydrogen based fuels. The prior art is replete with attempts to design simple, inexpensive hydrogen storage devices to address this need. These attempts include U.S. Pat. No. 4,838,606 to Hunter (Hydrogen Storage System); U.S. Pat. No. 6,074,453 to Anderson (Ultrafine Hydrogen Storage Powders); U.S. Pat. No. 6,143,052 to Kiyokawa (Hydrogen Storage Material); U.S. Pat. No. 6,672,077 to Bradley (Hydrogen Storage in Nanostructure with Physisorption); U.S. Pat. No. 5,906,792 to Schulz (Nanocrystaline Composite for Hydrogen Storage); U.S. Pat. No. 5,653,951 to Rodriguez (Storage of Hydrogen in Layered Nanostructures); and the like. The content of each of the aforementioned patents is hereby incorporated by reference into this specification.

One solution involves the use of carbon nanotubes as an apparatus for hydrogen storage. When these hollow tubes are exposed to hydrogen gas under certain conditions, the hydrogen gas is absorbed by them. In this manner, the tubes act as a hydrogen storage apparatus.

In an article by Angela Lueking and Ralph Yang (Fuel Cell Tdoay [online], [retrieved on Jul. 9, 2004]. Retrieved from the Internet <URL: http://www.fuelcelltoday.com/FuelCellToday/lndustryinformation/lndustrylnformation External/NewsDisplayArticle/0,1602,3159,00.html>) “An efficient storage media for hydrogen is desirable for the widespread application of fuel cells and the adoption of hydrogen as an energy source. The U.S. Department of Energy (DOE) has set a target of 6.5% by weight for hydrogen storage for new adsorbent materials. Although several metal hydrides are capable of meeting this target, the high desorption temperatures and slow desorption rates limit the widespread application of current metal hydrides. Recent advantages in carbon nanotechnology have been of interest to chemical engineers, as the development, large-scale production, purification, handling and uses of carbon nanofibers will require fundamental chemical engineering principles . . . . Carbon nanofibers, including single-walled carbon nanotubes (SWNTs), multiwall nanotubes (MWNTs), and graphite nanofibers (GNF), have shown promise for applications in hydrogen storage due to the electronic nature resulting of sp² hybridization, large surface areas, and molecular sized pores.” The article further teaches that certain levels of metal particles present in the carbon nanotubes results in variable levels of hydrogen absorption.

Both carbon and non-carbon nanotubes are known, but only carbon nanotubes have been used as hydrogen storage devices. Other, non-carbon nanotubes are known to exist, but have not been utilized as hydrogen storage devices. As disclosed in U.S. Pat. No. 6,401,816 to Price (Efficient Method for Subsurface Treatments, Including Squeeze Treatments) “Several naturally occurring minerals will, under appropriate hydration conditions, form tubules and other microstructures . . . The most common of these is halloysite, an inorganic aluminosilicate belonging to the kaolinite group of clay minerals . . . . In hydrated form the mineral forms good tubules. In dehydrated form the mineral forms broken, collapsed, split or partially unrolled tubules.” The entire content of U.S. Pat. No. 6,401,816 is hereby incorporated by reference into this specification. For additional information related to halloysite as well as other microtubule-like ceramics, reference may be had to U.S. Pat. No. 5,651,976 to Price (Controlled Release of Active Agents using Inorganic Tubules); U.S. Pat. No. 5,492,696 to Price (Controlled Release Microstructures); U.S. Pat. No. 5,705,191 to Price (Sustained Delivery of Active Compounds from Tubules, with Rational Control); U.S. Pat. No. 6,280,759 to Price (Method of Controlled Release and Controlled Release Microstructures); U.S. Pat. No. 5,246,689 to Beck (Synthetic Porous Crystalline Material Its Synthesis and Use); U.S. Pat. No. 4,098,676 to Robson (Synthetic Halloysites as Hydrocarbon Conversion Catalysts); U.S. Pat. No. 6,231,980 to Cohen (BX CY NZ Nanotubes and Nanoparticles); U.S. Pat. No. 4,960,450 to Schwarz (Selection and Preparation of Activated Carbon for Fuel Gas Storage); and the like. The content of each of the aforementioned United States patents is hereby incorporated by reference into this specification.

As is disclosed in U.S. Pat. No. 4,098,676 to Robson (Synthetic Halloysites as Hydrocarbon Conversion Catalysts) “Halloysite is a well-known kaolin clay mineral having the empirical formula Al₂O₃:2SiO₂:2H₂O . . . . Natural halloysite has been used heretofore in the petroleum art as a catalyst cracking catalyst.” Additional reference may be had to U.S. Pat. No. 4,150,099 to Robson (Sythetic Halloysite); and U.S. Pat. No. 6,207,793 to Kim (“Process for Production of Polytetramethylene-ether-glycol-diester using Halloysite catalyst). The contents of U.S. Pat. Nos. 4,098,676; 4,150,099; and 6,207,793 are hereby incorporated by reference into this specification. None of these patents suggest the use of halloysite in a hydrogen storage process or apparatus. Additionally, none of these patents suggest of use of a metallized halloysite for hydrogen storage.

The nomenclature for the mineral halloysite is not uniform. In the United States, the hydrated tubule form of the mineral is called endellite, and the dehydrated form is called halloysite. In Europe, the hydrated tubule form of the mineral is called halloysite, and the dehydrated form is called is called meta-halloysite. To avoid confusion, mineralogists will frequently refer to the hydrated mineral as halloysite 10 Å and the dehydrated mineral as halloysite 7 Å.

Lipid microstructures are likewise known in the art. Reference may be had to U.S. Pat. No. 4,867,917 to Schnur (Method for Synthesis of Diacetylenic Compounds); U.S. Pat. No. 4,877,501 to Schnur (Process for Fabrication of Lipid Microstructures); U.S. Pat. No. 4,911,981 to Schnur (Metal Clad Lipid Microstructures); U.S. Pat. No. 4,990,291 to Schoen (Method of Making Lipid Tubules by a Cooling Process); U.S. Pat. No. 5,049,382 to Price (Coating and Composition Containing Lipid Microstructure Toxin Dispensers); U.S. Pat. No. 5,492,696 to Price (Controlled Release Microstructures); U.S. Pat. No. 5,651,976 to Price (Controlled Release of Active Agents Using Inorganic Tubules); U.S. Pat. No. 5,705,191 to Price (Sustained Delivery of Active Compounds from Tubules, with Rational Control); and U.S. Pat. No. 6,280,759 to Price (Method of Controlled Release and Controlled Release Microstructures). The contents of each one of these patents is hereby incorporated by reference into this specification. None of these patents suggest the use of lipid microstructures in a hydrogen storage process or apparatus. Additionally, none of these patents suggest of use of a metalized lipid microstructures for hydrogen storage.

It is an object of this invention to provide processes and assemblies using metallized halloysite or metallized lipid microstructures for hydrogen storage.

### SUMMARY OF THE INVENTION

In accordance with the present invention, there is provided processes and assemblies using metallized halloysite or metallized lipid microstructures for hydrogen storage.

### BRIEF DESCRIPTION OF THE DRAWINGS

FIG. 1A is perspective view of a tubule;

FIG. 1B is an end view of the tubule in FIG. 1A; and

FIG. 2 is a flow diagram of a process of the invention.

FIG. 3 is a schematic perspective view of a hydrogen storage assembly of the invention.

### DESCRIPTION OF THE PREFERRED EMBODIMENTS

Carbon nanotubes are well known to those skilled in the art. Some of these nanotubes have found use as hydrogen storage devices. Reference may be had to U.S. Pat. No. 6,290,753 to Maeland (Hydrogen Storage in Carbon Material); U.S. Pat. No. 6,159,538 to Rodriguez (Method for Introducing Hydrogen into Layered Nanostructures); U.S. Pat. No. 6,294,142 to Nazri (Hydrogen Storage Systems and Method of Making Them); U.S. Pat. No. 6,517,800 to Cheng (Production of Singled-Walled Carbon Nanotubes by a Hydrogen Arc Discharge Method); U.S. Pat. No. 6,591,617 to Wolfe (Method and Apparatus for Hydrogen Storage and Retrieval); U.S. Pat. No. 6,596,055 to Cooper (Hydrogen Storage Using Carbon-Metal Hybrid Compositions); U.S. Pat. No. 6,672,077 to Bradley (Hydrogen Storage in Nanostructure with Physisorption); U.S. patent applications 2002/0150529; 2002/0187896; 2004/0011668; and 2004/0101466. The contents of U.S. Pat. Nos. 6,290,753; 6,159,538; 6,294,142; 6,517,800; 6,591,617; 6,596,055; 6,672,077; U.S. patent applications 2002/0150529; 2002/0187896; 2004/0011668; and 2004/0101466 are hereby incorporated by reference into this specification. Metallization of carbon based nanotubes has been shown to alter the hydrogen absorption ability of the nanotubues.

Without wishing to be bound to any particular theory, applicants believe that the addition of metals and/or metal salts to lipid tubules and halloysite tubules will improve the ability and increase the capacity of such tubules to store hydrogen gas. In one embodiment of the invention, metal particulates are imbedded within a microstructure. The resulting microstructure functions as an improved hydrogen storage assembly. In one such embodiment, the microstructure is a metallized lipid microtubule. In another such embodiment, the microstructure is metallized halloysite.

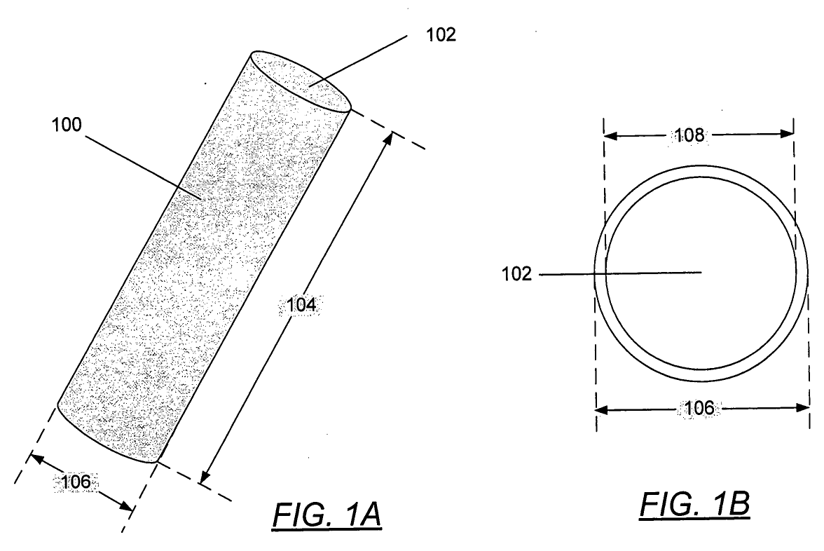

FIG. 1A is a perspective view of a single halloysite or lipid tubule 100 and FIG. 1B is an end view of such tubule 100. Tubule 100 is comprised of lumen 102. Without wishing to be bound to any particular theory, the applicants believe that molecular hydrogen may be disposed in lumen 102. Thus, halloysite or lipid tubule 100 may function as a hydrogen storage apparatus in a manner similar to the hydrogen storage capability of carbon nanotubes. The length 104 of halloysite or lipid tubules such as tubule 100 may vary from about 100 nm to about 1 μm or more. Transmission Electron Microscopy (TEM) shows that the inside diameter 108 of halloysite or lipid tubules range from about 0.02 to about 0.04 microns and outside diameter 106 varies from about 0.04 to about 0.08 microns. As used in this specification, the term “aspect ratio” refers to the ratio of the length 104 to the outside diameter 106. In one embodiment, halloysite or lipid tubules that have an aspect ratio of from about 1 to about 10 are selected. In another embodiment, halloysite or lipid tubules that have an aspect ratio of from about 2 to about 8 are selected. In yet another embodiment, such tubules that have an aspect ratio of from about 3 to about 10 are selected.

FIGS. 1A and 1B also illustrate another property of the halloysite or lipid tubules, their surface to volume ratio. The hollow lumen of the rods provides a high surface to volume ratio. In one embodiment, the halloysite or lipid tubules have a surface to volume ratio of about 1 to about 10,000. In another embodiment, such tubules have a surface to volume ratio of about 10 to about 1,000.

As used in this specification, certain terms are given special meaning within the context of this disclosure. The term “tubule,” “microtubule,” or “nanotube” is taken to mean a substantially hollow tube of microscale or nanoscale size, respectively. The term “metallized” is refers to the incorporation of a metal or metal oxide within or on the physical structure of the tubules. The term “lipid tubule” is given its ordinary meaning in the art and as such, may refer to tubuless comprised of phospholipids. Reference may be had to U.S. Pat. Nos. 5,096,551 and 6,013,206; the entire disclosures of which are hereby incorporated by reference into this specification. The term “hydrogen storage ability” refers to the ability of a material to absorb and hold hydrogen for a prolonged period of time and is measured in terms of the percent weight of hydrogen retained with the substrate. The United States Department of Energy has set a target of 6.5% by weight for hydrogen storage ability.

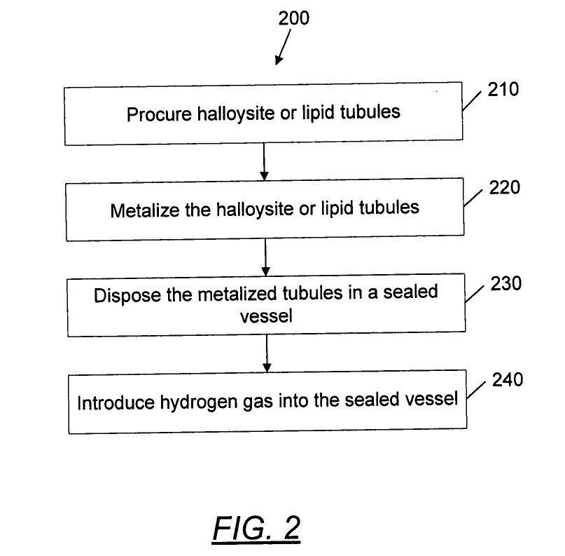

FIG. 2 is a flow diagram of a preferred embodiment of a process 200 for using metalized halloysite or lipid tubules for the storage of hydrogen. In step 210 either halloysite or lipid tubules are procured from the sources or processes described elsewhere in this specification. In step 220 such halloysite or lipid tubules are metalized by any of the metalizing processes described elsewhere in this specification. In step 230 the metalized tubules are disposed in a sealed vessel so as to substantially fill all of the free space within the vessel. In step 240 hydrogen is introduced into the sealed vessel through a valve sealingly attached the vessel. The hydrogen is absorbed by the metalized tubules in the vessel and, when required for final use, released through the valve.

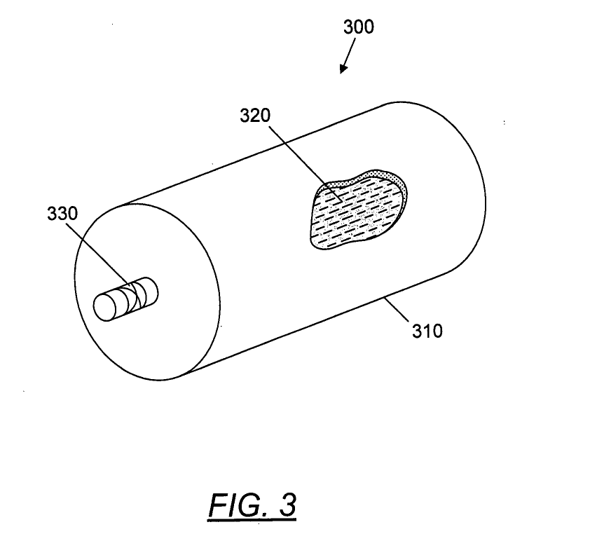

FIG. 3 is a schematic perspective view of hydrogen storage assembly 300 produced by process 200. Either metalized halloysite or lipid tubules 320 completely fill the free space within sealed vessel 310. Hydrogen is introduced into vessel 310 through open valve 330 and is absorbed by tubules 320. Valve 330 is closed until delivery of the hydrogen is desired.

Applicant's co-pending U.S. patent application Ser. No. 11/042,219 discloses sources of halloysite and teaches a process for separation, purification, and/or classification of tubules of the halloysite clay. U.S. Ser. No. states: “Halloysite is mined and sold commercially from mines in New Zealand and in Juab County, Utah. Reference may be had to http://www.atlasmining.com/dragonmine.html, the web site of the Atlas Mining Company of Osborn, Id. which describes and shows certain operations of the Dragon Mine in the Tintic Mining District in Joab County, Utah. Although the halloysite clay obtained from the Dragon Mine is among the highest in purity and in proportion of microtubules, such halloysite clay is not obtained in a state that is suitable for direct use as a vehicle for loading and controlled release of active agents.”

U.S. Ser. No. 11/042,219 further states: “There is therefore a need to provide economically viable large scale processes for the separation, purification, and/or classification of microtubules of halloysite clay, and microtubules of other inorganic minerals including but not limited to imogolite, cylindrite, and boulangerite. Accordingly, embodiments of the present invention are provided herein that meet at least one or more of the following objects of the present invention.

It is an object of this invention to provide a process for the initial comminution and purification of inorganic microtubules, such as halloysite microtubules.

It is an object of this invention to provide a process for the size classification of purified inorganic microtubules, such as halloysite microtubules.

It is a further object of this invention to provide a complete process for the preparation of highly purified inorganic microtubules, such as halloysite microtubules, from initial comminution, to the delivery of a liquid microtubule dispersion or dry microtubule powder that is ready to be further incorporated into a useful product or process.

It is a further object of this invention to provide novel microstructures comprising halloysite microtubules containing an active agent, which is released in a controlled manner into a targeted area within such microstructure.

It is a further object of this invention to provide novel structures comprising halloysite microtubules containing an active agent, which is released in a controlled manner into at least one specified location proximate to such structure.”.

In one embodiment of the invention, a metallized lipid microtubule or nanotube is produced using the techniques described in U.S. Pat. No. 5,096,551 to Schoen (Metallized Tubule-Based Artificial Dielectric). As is disclosed in U.S. Pat. No. 5,096,551, “The production of lipid tubules is well known. For example, U.S. Pat. No. 4,877,501 to Schnur et al, incorporated herein by reference, teaches the production of tubular and/or helical microstructures from selected lipids and especially from lipids containing diacetylenic moieties. U.S. Pat. No. 4,911,981, also to Schnur et al. and incorporated hereby by reference, describes metallized microstructures produced by electroless plating of lipid tubules aided by the prior absorption of a catalytic precursor to the lipid microstructure. That patent also describes the incorporation of the metallized lipid microstructures into a polymer matrix. The thus produced composites, in which the metal-clad lipid microstructures are randomly oriented within the matrix, can provide useful electrical components such as inductors, capacitors and low loss electrical connectors, depending on the geometry of the lipid microstructure and the properties of the metal coating.” The content of U.S. Pat. Nos. 4,877,501; 4,911,981; and 5,096,551 are hereby incorporated by reference into this specification.

In another embodiment, a metallized lipid nanotube is produced using the techniques described in U.S. patent application 2004/0034122 to Lacy (Golf Ball Compositions Comprising Metallized Lipid-Based Nanotubules). As is disclosed in paragraph 0019 of this application, nanotubules may “ . . . contain a metal (on the inner and/or outer surfaces). The tubules can be metallized with any metal (or alloy thereof) capable of being plated. Metal tubules may be prepared by plating a metal on a filament which is soluble in a hydrocarbon solvent, to form an outer layer of metal, and then removing the central filament by exposure to a hydrocarbon solvent. Alternatively, a porous membrane may be plated with a metal to form a layer of metal on the inside surface of the pores, dissolution of the membrane, and collection of the metal tubules. Once coated with metal, the tubules are filtered to remove the solvent and are air dried to a powdered form.” This application further notes that known tubes range in size “from about 50 nm to about 20 μm, preferably from about 100 nm to about 1 μm, and most preferably from about 200 nm to about 800 nm. The inner diameter of the tubules and the desired time period of release may be controlled by varying the conditions used to produce the tubules. These include choice of active agent, carrier, environment surrounding the tubule, and other components of the composition.” As would be apparent to one skilled in the art, the tubule sizes which were preferred for Lacy's Golf ball invention are not necessarily the same as the sizes preferred for the subject hydrogen storage apparatus. The entire content of U.S. patent application 2004/0034122 is hereby incorporated by reference into this specification.

Additional methods of making metallized lipid microtubules include U.S. Pat. No. 6,013,206 to Price (Process for the Formation of High Aspect Ratio Lipid Microtubules). As is disclosed in this patent “Lipid microtubules having a controlled bilayer structure and high aspect ratio are formed in a methanol/ethanol/water solvent system. The lipid microtubules may then be catalyzed (e.g., with a palladium/tin catalyst) in an acidified catalytic bath having no more than about 30 g of catalytic salts. These catalyzed microtubules are then metallized using a diluted plating bath with replenishment of the plating bath as needed to obtain the desired metallization thickness.”

Applicants have discovered that certain halloysites are comprised of tubules similar to carbon nanotubes. Similarly, it is also know that other halloysites are comprised of tubule-like structures. Without wishing to be bound to any particular theory, applicants believe that the tubular structure of certain halloysites causes them to function as hydrogen storage devices. In one embodiment of the invention, halloysite microstructures are metallized so as to increase their hydrogen storage ability. In one embodiment, the metallization of halloysite causes the halloysite's hydrogen storage ability to increase by at least about 0.5% by weight. In another embodiment, the metallization of halloysite causes the halloysite's hydrogen storage ability to increase by at least about 0.1% by weight.

The metal incorporated techniques referenced above typically result in modest incorporation of metals into the microstructure. In one embodiment, at least about 1% by weight of the microstructure is metallic. In another embodiment, between 1% and 10% by weight of the microstructure is metallic. In another embodiment, between 1 and 5% by weight of the microstructure is metallic. It is generally desirable to achieve a relatively high metal concentration without sacrificing the porous structure of the tubular microstructure.

A variety of metal and/or metal oxides may be incorporated into halloysite or lipid microstructures. For example, one may incorporate Fe, Co, Ni, Mg, MgO, alloys such as Ni_{X}Mg_{Y}O_{X} and the like. In addition to those methods specifically illustrated above, numerous other methods for metallizing microstructures are well known to those skilled in the art.

It is, therefore, apparent that there has been provided, in accordance with the present invention, a method and apparatus for hydrogen storage comprised of metallized lipid tubules or metallized halloysite. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. A process for storing hydrogen comprising:
a. Coating haloysite with a metal to create metalized halloysite;
b. disposing a quantity of said metalized halloysite in a sealed vessel;
c. introducing a volume of said hydrogen into said sealed vessel whereby said hydrogen is absorbed into said metalized halloysite.

2. The process as recited in claim 1, wherein said halloysite is comprised of at least 30 weight percent of halloysite tubules.

3. The process as recited in claim 2, wherein said halloysite tubules have a length in the range from about 0.1 to about 1000 microns and a diameter in the range from about 0.02 to about 1.0 microns.

4. The process as recited in claim 3, wherein at least about 80 weight percent of said halloysite tubules have an aspect ratio of said length to said diameter of from about 2 to about 10.

5. The process as recited in claim 4, wherein at least about 80 weight percent of said halloysite tubules have an aspect ratio of said length to said diameter of from about 2 to about 8.

6. The process as recited in claim 1, wherein said metal is selected from the group consisting of copper, iron, cobalt, nickel, magnesium, alloys of each of these metals, and oxides of each of these metals.

7. The process as recited in claim 6, wherein said metalized halloysite is comprised of between about 1% and about 10% by weight of said metal.

8. The process as recited in claim 4, wherein said metal is selected from the group consisting of copper, iron, cobalt, nickel, magnesium, alloys of each of these metals, and oxides of each of these metals.

9. The process as recited in claim 8, wherein said metalized halloysite is comprised of between about 1% and about 10% by weight of said metal.

10. An assembly for storing hydrogen comprising halloysite, said halloysite having a coating of a metal thereon thereby becoming metalized halloysite, a quantity of said metalized halloysite disposed in a sealed vessel, said sealed vessel having a valve attached thereto for introducing said hydrogen therein.

11. The assembly as recited in claim 10, wherein said halloysite is comprised of at least 30 weight percent of halloysite tubules.

12. The assembly as recited in claim 11, wherein said halloysite tubules have a length in the range from about 0.1 to about 1000 microns and a diameter in the range from about 0.02 to about 1.0 microns.

13. The assembly as recited in claim 12, wherein at least about 80 weight percent of said halloysite tubules have an aspect ratio of said length to said diameter of from about 2 to about 10.

14. The assembly as recited in claim 13, wherein at least about 80 weight percent of said halloysite tubules have an aspect ratio of said length to said diameter of from about 2 to about 8.

15. The assembly as recited in claim 10, wherein said metal is selected from the group consisting of copper, iron, cobalt, nickel, magnesium, alloys of each of these metals, and oxides of each of these metals.

16. The assembly as recited in claim 15, wherein said metalized halloysite is comprised of between about 1% and about 10% by weight of said metal.

17. The assembly as recited in claim 13, wherein said metal is selected from the group consisting of copper, iron, cobalt, nickel, magnesium, alloys of each of these metals, and oxides of each of these metals.

18. The assembly as recited in claim 17, wherein said metalized halloysite is comprised of between about 1% and about 10% by weight of said metal.

19. A process for storing hydrogen comprising:
a. Coating a lipid microstructure with a metal to create a metalized lipid microstructure;
b. disposing a quantity of said metalized lipid microstructure in a sealed vessel;
c. introducing a volume of said hydrogen into said sealed vessel whereby said hydrogen is absorbed into said metalized lipid microstructure.

20. The process as recited in claim 19, wherein said lipid microstructure is comprised of lipid tubules.

21. The process as recited in claim 20, wherein said lipid tubules are phospholipid tubules.

22. The process as recited in claim 20, wherein said lipid tubules have a length in the range from about 0.1 to about 1000 microns and a diameter in the range from about 0.02 to about 1.0 microns.

23. The process as recited in claim 22, wherein at least about 80 weight percent of said lipid tubules have an aspect ratio of said length to said diameter of from about 2 to about 10.

24. The process as recited in claim 23, wherein at least about 80 weight percent of said lipid tubules have an aspect ratio of said length to said diameter of from about 2 to about 8.

25. The process as recited in claim 19, wherein said metal is selected from the group consisting of copper, iron, cobalt, nickel, magnesium, alloys of each of these metals, and oxides of each of these metals.

26. The process as recited in claim 25, wherein said metalized lipid microstructure is comprised of between about 1% and about 10% by weight of said metal.

27. The process as recited in claim 23, wherein said metal is selected from the group consisting of copper, iron, cobalt, nickel, magnesium, alloys of each of these metals, and oxides of each of these metals.

28. The process as recited in claim 27, wherein said metalized lipid microstructure is comprised of between about 1% and about 10% by weight of said metal.

29. An assembly for storing hydrogen comprising a lipid microstructure, said lipid microstructure having a coating of a metal thereon thereby becoming a metalized lipid microstructure, a quantity of said metalized lipid microstructure disposed in a sealed vessel, said sealed vessel having a valve attached thereto for introducing said hydrogen therein.

30. The assembly as recited in claim 29, wherein said lipid microstructure is comprised of lipid tubules.

31. The process as recited in claim 30, wherein said lipid tubules are phospholipid tubules.

32. The assembly as recited in claim 30, wherein said lipid tubules have a length in the range from about 1 to about 1000 microns and a diameter in the range from about 0.1 to about 1.0 microns.

33. The assembly as recited in claim 32, wherein at least about 80 weight percent of said lipid tubules have an aspect ratio of said length to said diameter of from about 2 to about 10.

34. The assembly as recited in claim 33, wherein at least about 80 weight percent of said lipid tubules have an aspect ratio of said length to said diameter of from about 2 to about 8.

35. The assembly as recited in claim 29, wherein said metal is selected from the group consisting of copper, iron, cobalt, nickel, magnesium, alloys of each of these metals, and oxides of each of these metals.

36. The assembly as recited in claim 35, wherein said metalized lipid microstructure is comprised of between about 1% and about 10% by weight of said metal.

37. The assembly as recited in claim 33, wherein said metal is selected from the group consisting of copper, iron, cobalt, nickel, magnesium, alloys of each of these metals, and oxides of each of these metals.

38. The assembly as recited in claim 37, wherein said metalized lipid microstructure is comprised of between about 1% and about 10% by weight of said metal.
